(19) United States
(12) Patent Application Publication
(10) Pub. No.: US 2025/0209895 A1
(43) Pub. Date: Jun. 26, 2025

(54) Wearable device concept powered by a combination of soft pneumatic actuators and variable stiffness knitting

(71) Applicants: The Board of Trustees of the Leland Stanford Junior University, Stanford, CA (US); Massachusetts Institute of Technology, Cambridge, MA (US)

(72) Inventors: Cosima Du Pasquier, Stanford, CA (US); Allison M. Okamura, Mountain View, CA (US); Skylar Tibbits, Cambridge, MA (US); Lavender Tessmer, Cambridge, MA (US); Ian Andreas Scholl, Horw (CH)

(21) Appl. No.: 18/982,345

(22) Filed: Dec. 16, 2024

Related U.S. Application Data
(60) Provisional application No. 63/612,894, filed on Dec. 20, 2023.

(51) Int. Cl. G08B 6/00

(52) U.S. Cl. CPC G08B 6/00

(57) ABSTRACT

A pneumatic haptic sleeve is provided which is knit in one piece with a top side and a bottom side. The top side has a relatively soft and stiff stiffness areas. The soft areas are of increasing stiffness, where the softest is right beneath pneumatic actuators and allows for actuator deformation. The high stiff area is above and around the pneumatic actuators. The pneumatic actuators fit within the knitted sleeve such that the top side of the pneumatic actuator matches up with the high stiffness area, and the bottom side of the pneumatic actuator matches up with the low stiffness area. The pneumatic actuator has two states: actuated and non-actuated. The pneumatic haptic sleeve is portable, self-contained, and comfortable to wear, thereby promoting extended wearability and more consistent use in mediated social touch applications.

### CROSS-REFERENCE TO RELATED APPLICATIONS

This application claims priority from U.S. Provisional Patent Application 63/612,894 filed Dec. 20, 2023, which is incorporated herein by reference.

### STATEMENT OF GOVERNMENT SPONSORED SUPPORT

This invention was made with Government support under contract 2301355 awarded by the National Science Foundation. The Government has certain rights in the invention.

### FIELD OF THE INVENTION

This invention relates to wearable devices. In particular, the invention relates to pneumatic actuators for wearable devices in combination with variable stiffness areas.

### BACKGROUND OF THE INVENTION

Social touch, tactile interaction between individuals, plays a critical role in emotional communication, cognitive development, and overall well-being. The absence of such interaction in remote communication environments has become increasingly problematic, particularly in circumstances like global pandemics where in-person contact is limited. This lack of touch in virtual settings reduces the emotional richness of interactions and can lead to feelings of isolation, anxiety, and loneliness.

Soft mediated touch through wearable haptic devices offers a promising solution to this problem, but current technologies remain limited. While pneumatic and hydraulic actuators can provide more nuanced and information-rich feedback than simple vibrations, their integration into fully soft, lightweight, and unobtrusive wearables remains challenging. Producing consistent and reliable force anchoring using only soft materials is difficult, resulting in devices that cannot easily maintain stable contact pressure or scale to deliver multiple points of tactile feedback without interference. As a result, these devices have not yet achieved the desired level of comfort, wearability, and fidelity needed to restore the sense of social touch in remote interactions.

### SUMMARY OF THE INVENTION

In one embodiment the invention is characterized by a pneumatic haptic sleeve. The pneumatic haptic sleeve is knit in one piece with a top side shown in FIG. 1A and a bottom side illustrated through the cross-section in FIG. 1B. The top side has four stiffness areas, three of which are soft (stiffness <1 N/mm) and one stiff (stiffness >1 N/mm), as shown in FIG. 1A. The soft areas are of increasing stiffness, where the softest of 0.122 N/mm is right beneath the actuators, as shown in the cross-section in FIG. 1B, and allows for actuator deformation. This area is designated as a low stiffness area. The soft area of 0.603 N/mm is designed for ease of hose routing and shape retention. The soft area of 1.03 N/mm allows for comfortable fit around the arm. The stiff area of 9.78 N/mm is above and around the actuators shown FIG. 1B, which is referred to as a high stiffness area.

In one embodiment the invention is characterized by a pneumatic haptic sleeve with a knitted sleeve with a top side having a top stiffness area and a bottom side having a bottom stiffness area. The top stiffness area is a high stiffness area which is different from and relative to the bottom stiffness area which is a low stiffness area.

In one embodiment, the high stiffness area is an area with a varying topology. Similarly, in another embodiment, the low stiffness area is a knitted area with a varying topology.

In one embodiment, the high stiffness area could have heat-fusible fibers or heat-fusible thermoplastics. In one embodiment, the low stiffness area could be a knitted area of elastic yarn.

The pneumatic haptic sleeve further distinguishes a pneumatic actuator that has a top side and a bottom side. The pneumatic actuator fits within the knitted sleeve such that the top side of the pneumatic actuator matches up with the high stiffness area, and the bottom side of the pneumatic actuator matches up with the low stiffness area.

The pneumatic actuator has two states: actuated and non-actuated.

In the non-actuated state, the top side ranges from being a concave top side to at most a flat top side. In the non-actuated state, the bottom side ranges from being a concave bottom side to at most a flat bottom side.

In the actuated state, the top stiffness area limits or prevents bulging resulting from the actuated pneumatic actuator at the top stiffness area such that the top side, while in this actuated state, ranges from between the concave top side to at most the flat top side.

In the actuated state, the bottom stiffness area allows bulging resulting from the actuated pneumatic actuator at the bottom stiffness area, such that the bottom side, while in this actuated state, ranges from between the concave bottom side to a convex bottom side.

The disclosed invention and its embodiments offer several advantages. First, the manufacturing process is greatly simplified, as the knitted structure can be produced in a single step without needing to assemble multiple separate components. Additionally, the sleeve-like design allows for easy donning and doffing, enhancing user convenience. The system is also portable, self-contained, and comfortable to wear, thereby promoting extended wearability and more consistent use in mediated social touch applications.

### BRIEF DESCRIPTION OF THE DRAWINGS

The figures are converted from color drawings into black/white or grey scale drawings. The reader is referred to the priority document for the colored drawings.

FIG. 1A shows according to an exemplary embodiment of the invention the top side of the Haptiknit sleeve which is composed of zones of varying stiffness.

FIG. 1B shows according to an exemplary embodiment of the invention how the Haptiknit sleeve is composed of stiff and soft layers and embedded pneumatic actuators. The eight actuators can be inflated to provoke haptic feedback on the arm, inflating in the soft direction and remaining encased in the stiff direction.

FIG. 1C shows according to an exemplary embodiment of the invention the pneumatic supply used to control the actuators in the sleeve with positive and negative pressure pumps. Each of the eight actuators is attached to a solenoid valve; the system is powered by battery (untethered); all electromechanical components are controlled using a microcontroller.

FIGS. 2A-D show according to an exemplary embodiment of the invention how varying topology and bonding fiber content in the sleeve affects the stiffness; it shows how in (FIG. 2A) topology variations affects the force-displacement response of low-stiffness fabrics, how in (FIG. 2B) the addition of thermoplastic fibers affects the force-displacement curves for high-stiffness fabrics, how in (FIG. 2C) the heat-setting of thermoplastic fibers affects the force-displacement curve of fabric D, and how in (FIG. 2D) the previously mentioned topological and material variations affect the effective stiffness in N/mm overall; a microscopic view with a magnification of 50 is shown for each fabric to the left of their respective graphs.

FIG. 3 shows according to an exemplary embodiment of the invention a 3D rendering of the Haptiknit sleeve. The embodiment shows how the sleeve is composed of five fabric layers, which are the same color code as those shown in FIGS. 2A-D. The 2D view of the sleeve shows how the eight actuators are numbered and connected to pneumatic hoses on either side; each coin actuator is controlled separately.

FIGS. 4A-D show according to an exemplary embodiment of the invention the pneumatic actuator geometry and characterization results. The uninflated actuator and section view indicators are shown in (FIG. 4A). The inflated actuator as used in blocked force experiments is shown in (FIG. 4B). The section view and dimensions of the actuator are shown in (FIG. 4C)-three thicknesses are tested in characterization: t=1, 1.5, 2 mm; Blocked force (F) vs. pressure characterization results are shown in (FIG. 4A), where in the legend F indicates Flexible 80A and E Elastic 50A, the following number indicates the thickness in mm, the line type indicates whether the actuator was tested unconstrained or constrained by high- and low-stiffness fabrics; the vertical displacement (FIG. 4D) vs. pressure is shown in (FIG. 4E), same legend as in (FIG. 4D).

FIG. 5 shows according to an exemplary embodiment of the invention the actuator frequency characterization results. The frequency response magnitude is shown in gold for displacement and blue for force. The bandwidth (−3 dB magnitude) for both measures is marked with black dashed lines.

FIGS. 6A-B show according to an exemplary embodiment of the invention stroking continuity and pleasantness ratings. The mean continuity (FIG. 6A) and pleasantness (FIG. 6B) ratings for three stroke durations and three delays are shown, including error bars showing the maximum and minimum values scored; the delay represents how much overlap in actuation each consecutive actuator had with the previous.

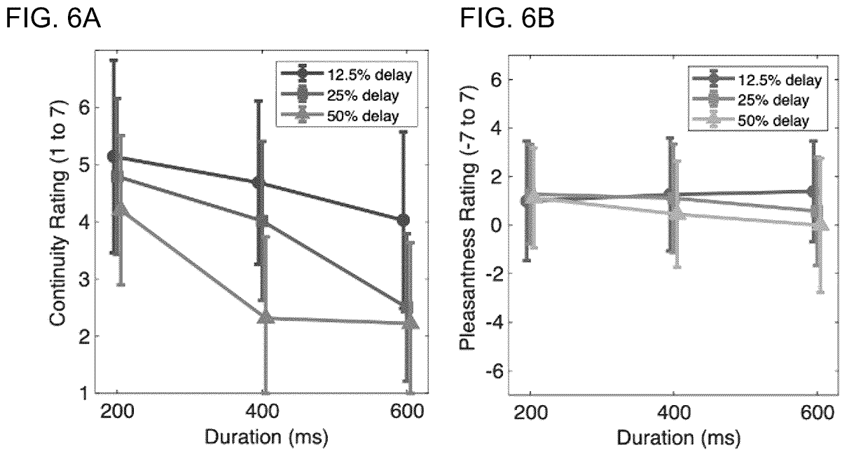

FIG. 7 shows according to an exemplary embodiment of the invention actuatory localization accuracy results for each actuator position. Each graph shows the actuator localization guesses for the eight actuator locations; the graphs' counts indicate how many times the location was guessed across all participants and runs.

FIG. 8 shows according to an exemplary embodiment of the invention a confusion matrix of the normalized top choice results for the six emotions communicated in the social touch study. The highest values for participant top choice for each rendered gesture are outlined in gold. The rating scale is given on the right, where the darker the hue of blue, the more the emotion was guessed by participants.

FIGS. 9A-B show according to an exemplary embodiment of the invention user post experiment ratings of the sleeve according to an exemplary embodiment of the invention; whisker-box plots of the post experiment ratings are shown of (FIG. 9A) location and gesture task accuracy (self-assessed and measured), (FIG. 9B) self-assessed qualitative description of the sleeve.

FIG. 10 shows according to an exemplary embodiment of the invention the uniaxial characterization test setup. The figure shows how force-displacement curves and Young's Modulus are measured for each fabric type using uniaxial testing. PPMA clamps are used to secure the square specimen at 40 mm distance to one another. The actuator attached to the load cell moves up and away from the fixed boundary to provide uniaxial tension.

FIGS. 11A-D show according to an exemplary embodiment of the invention the characterization test setup used to measure the results in FIGS. 4D and E. (FIG. 11A) and (FIG. 11B) show the blocked force test setup corresponding to FIG. 4D, where a force sensor is mounted under the actuator. In (FIG. 11A) the force is measured without fabric. in (FIG. 11B) the force is measured with fabric; (FIG. 11C) and (FIG. 11D) show the displacement characterization test setup, where displacement is measured using a stereo camera and a ruler for scaling; in (FIG. 11C) the displacement is measured without fabric; in (FIG. 11D) the displacement is measured while constraining the actuator by fabric (low- and high-stiffness).

FIG. 12 according to an exemplary embodiment of the invention the assembly process of the knit sleeve.

### DETAILED DESCRIPTION

Wearable haptic devices typically rely on rigid actuators and a bulky power supply system, limiting comfort and mobility. Soft materials improve wearability, but careful distribution of stiffness is required to ground actuation forces and enable load transfer to the skin.

With this invention, the inventors present Haptiknit, an approach in which soft, wearable, knit textiles with embedded pneumatic actuators enabling programmable haptic display. By integrating pneumatic actuators within relatively high- and low-stiffness machine-knit layers, each actuator is able to transmit forces beyond 40 N with a bandwidth of 14.5 Hz. The inventors demonstrated the concept with an adjustable sleeve for the forearm coupled to an untethered pneumatic control system that can convey a diverse array of social touch signals. The sleeve's performance was assessed for discriminative and affective touch in a three-part user study and compared our results to those of prior electromagnetically actuated approaches. The Haptiknit approach improves touch localization compared to vibrotactile stimulation and communicates social touch cues more pleasantly and with fewer actuators than pneumatic textiles that do not invoke distributed stiffness. The Haptiknit sleeve resulted in similar recognition of social touch gestures compared to a similar voice-coil array, while in a more portable and comfortable form factor.

Although often ignored, touch is crucial in performing everyday tasks, from tying our shoelaces, to walking, cooking, and typing. Without touch feedback, we lose an enormous component of our interaction with the world, in particular with other human beings. It plays a crucial role in daily social interactions, including flirting, expressing power, and playing. Contrary to the belief that touch merely complements speech or vision, it can serve as the sole communication channel for various emotions. Human tactile perception results from the integration of signals from diverse skin mechanoreceptors, each specialized in responding to specific stimuli. For example, Pacinian corpuscles detect high-frequency vibrations, Meissner corpuscles respond to the rate of skin deformation, Merkel discs focus on spatial features, and Ruffini endings are sensitive to skin stretch. Additionally, hairy skin, like that on the forearm, houses C tactile (CT) afferents activating the insular cortex, a region implicated in emotional processing. Wearable haptic devices aim to enhance touch interactions, offering new possibilities in conveying nuanced and realistic tactile experiences. They can be used to provide guidance, convey abstract information like emotions or mood, or provide additional inputs in multitasking. While touch interaction is crucial in our interaction both with state-of-the-art research devices and commercial products like smartwatches, they primarily rely on vibration feedback from electromagnetic actuators due to constraints in actuator size, weight, power, and robustness for mass production. However, this approach has limitations in transmitting information effectively, given the broad receptive fields of human mechanoreceptors responding to vibration and the challenge in realistically conveying slowly varying touch interactions.

An alternative approach to mobile touch interaction has been emerging, inspired by the field of soft robotics. Pneumatic actuators can produce displacement, shear, and compression to communicate information to the wearer. Pneumatics are attractive because they can achieve relatively high forces at high response rates. Soft actuators also have a stiffness profile close to that of skin, promoting conformity and comfort. However, the use of exclusively soft materials comes at a cost: they do not typically offer strong grounding, which limits the achievable intensity of reaction forces and sensations. For example, the soft linear pneumatic actuators embedded in the haptic device produce e.g. a maximum force of 0.7 N. To address this issue, current pneumatic haptic sleeve designs use large, distributed actuation to produce generalized sensations of compression and stretch, but require bulky and rigid hardware for pressure regulation and monitoring that hinder mobility and comfort.

The present invention is a new design paradigm to address this issue: combining soft pneumatic actuators with knits. The modernization of knitting has transformed this millennia-old tradition into a state-of-the-art industrial fabrication method. Knit textiles hold two main advantages that make them attractive in applications driven by human-computer interaction (HCl): their inherent compliance, that allows them to conform to doubly curved surfaces without compromising their flexibility, and the high-resolution control that flatbed knitting gives the designer over local material properties, through local specification of the material, pattern, and stitch. Like soft pneumatic actuators, the capacity of knits to adapt to the wearer's morphology promotes comfort and usability. The potential of knits for human-computer interaction is evidenced by knit sensing interfaces with conductive yarns embedded in wearable garments, as well as modulations in stitch and material to control pneumatic deformation in a manner similar to classic fiber-reinforced elastomeric enclosures. In the art, knitting as a source of haptic feedback with KnitDermis was showcased, which provides tactile stimulation through SMA micro-springs integrated in knit channels, and later, a tubular actuated knit robot that can travel up the arm was introduced. However, the full potential of industrial automated knitting for haptic applications remains underdeveloped; there are few examples that leverage embedded material properties and incorporate component assemblies. Existing research only employs knit fabric as a passive armature and a vehicle, rather than an active component of the system.

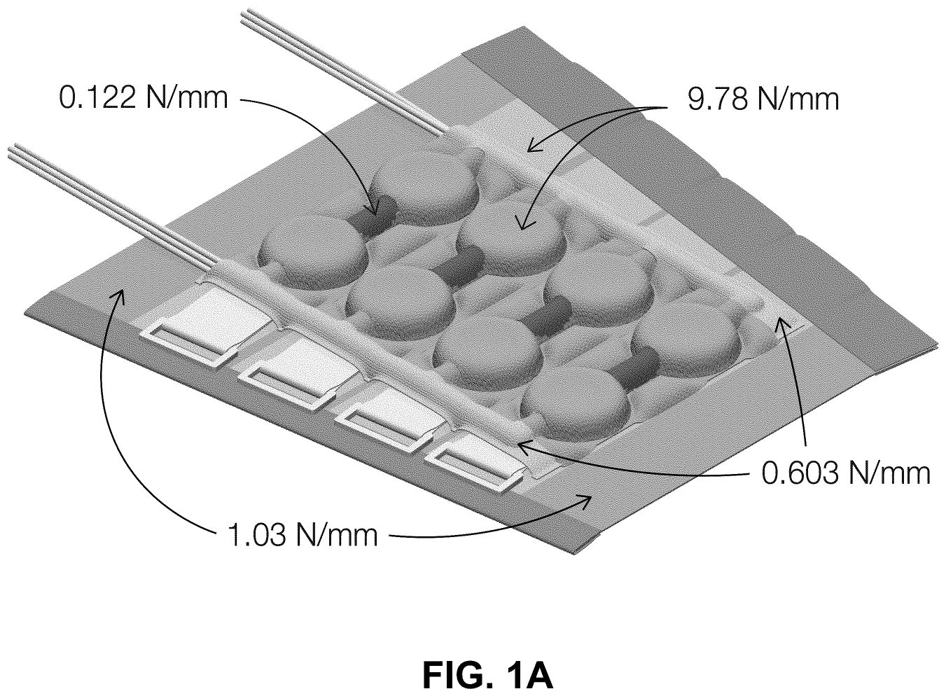

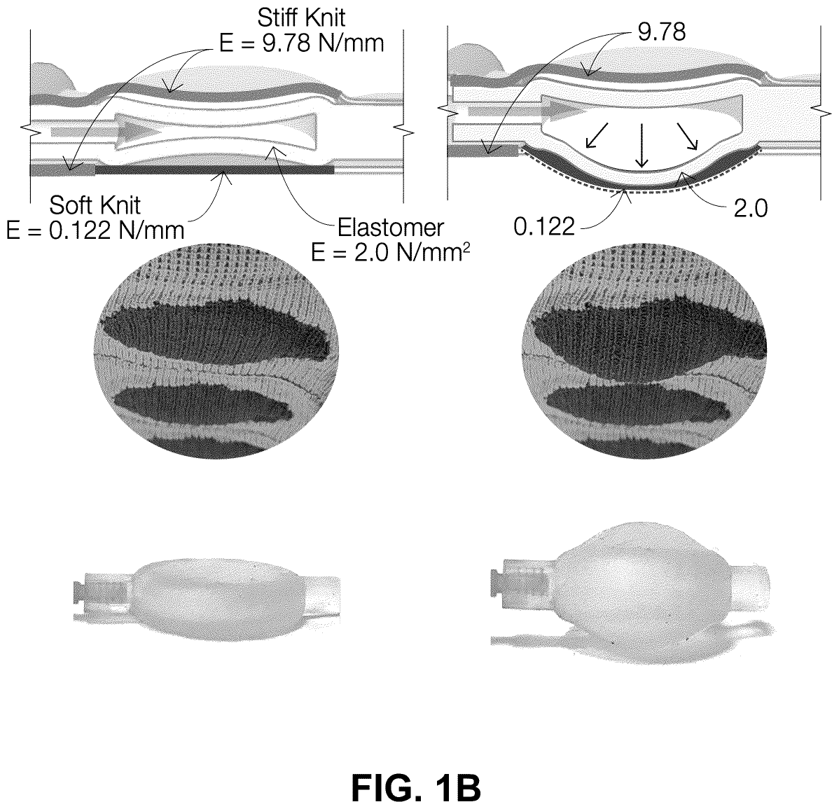

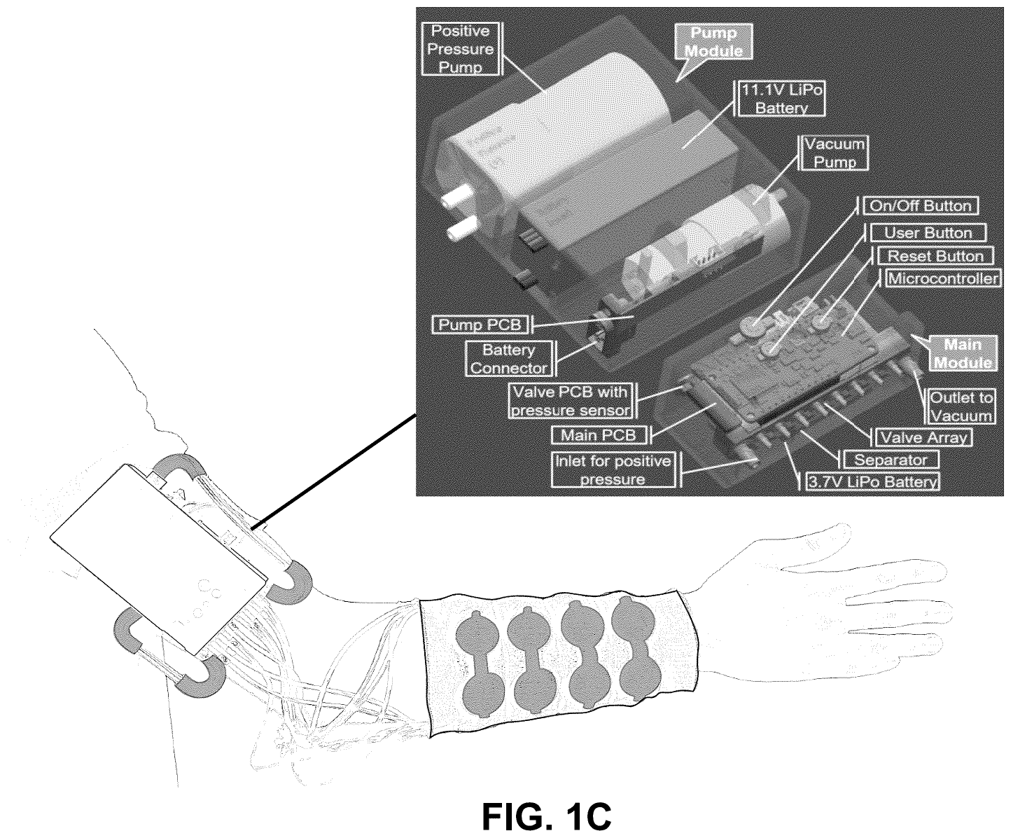

With this invention, the inventors propose to use distributed stiffness knitting to enable perceivable patterned haptic sensations, an approach called Haptiknit. This concept is embodied in a fully integrated soft pneumatic haptic sleeve with distributed stimulation to the skin of the forearm. The sleeve itself is knitted as one piece, comprised of two main layers, subdivided into six textile sub-layers, that achieve highly contrasting stiffness values. Designed and shaped to conform to the forearm, it allows seamless integration of multiple sets of soft actuators through the selective use of heat-fusible yarn. In this configuration, each actuator can achieve forces beyond 40 N. It is powered by an unencumbered, light, and untethered pneumatic supply system we designed to be worn on the forearm. The sleeve and pneumatic supply are shown in FIGS. 1A-B respectively. The applicability of the approach to social touch was validated by replicating the actuator configuration of another haptic sleeve that used voice-coil motors and benchmarking the device on similar use cases.

Contributions are the following:
distributed stiffness knit approach effectively delivers haptic feedback that could be used in many haptic applications beyond social touch;
Demonstrated displacement, force generation, and frequency response of 3D printed soft actuators for integration with a Haptikit sleeve;
showcased the Haptiknit sleeve's performance for discriminative and affective touch in a three-part human user study;
provide a portable and compact untethered pneumatic system that allows the Haptiknit sleeve to be worn as a self-contained unit.

### Distributed Stiffness Knitting

The distribution of stiffness temporally or topologically in a design unlocks a slew of new applications where the function is directly embedded within the build material. CNC knitting, the modern form of industrial knitting, is unique among scalable methods of textile manufacturing, offering the ability to integrate multiple materials and material properties into seamless fabric constructions and at high resolution.

Stiffness in a knit can be varied through the choice of textile topology (type of knot, type of pattern) and material. It was recently shown that a change in topology can increase the Young's modulus of a knit by a factor of 20 in the course direction and of 40 in the wale direction. Several materials have also been tested, showing an increase in stiffness by a factor of 14, although they only used inelastic yarn. Although this amount of stiffening showcases the abilities of knitting, it falls short of the required variation necessary to completely encase and direct a soft pneumatic actuator.

Another approach to stiffening a textile is to add a heat fusing agent during fabrication. It is built-in in the form of a yarn, that is melted in a postprocessing step and produces a global stiffening effect. Fused, or bonded, fabrics are common in industrial applications, for example in shoemaking, but have not yet been used in distributed stiffness research. Here we propose to control the stiffness in a single knit textile by modifying topology, yarn material, and by including thermoplastic fibers in high-stiffness regions.

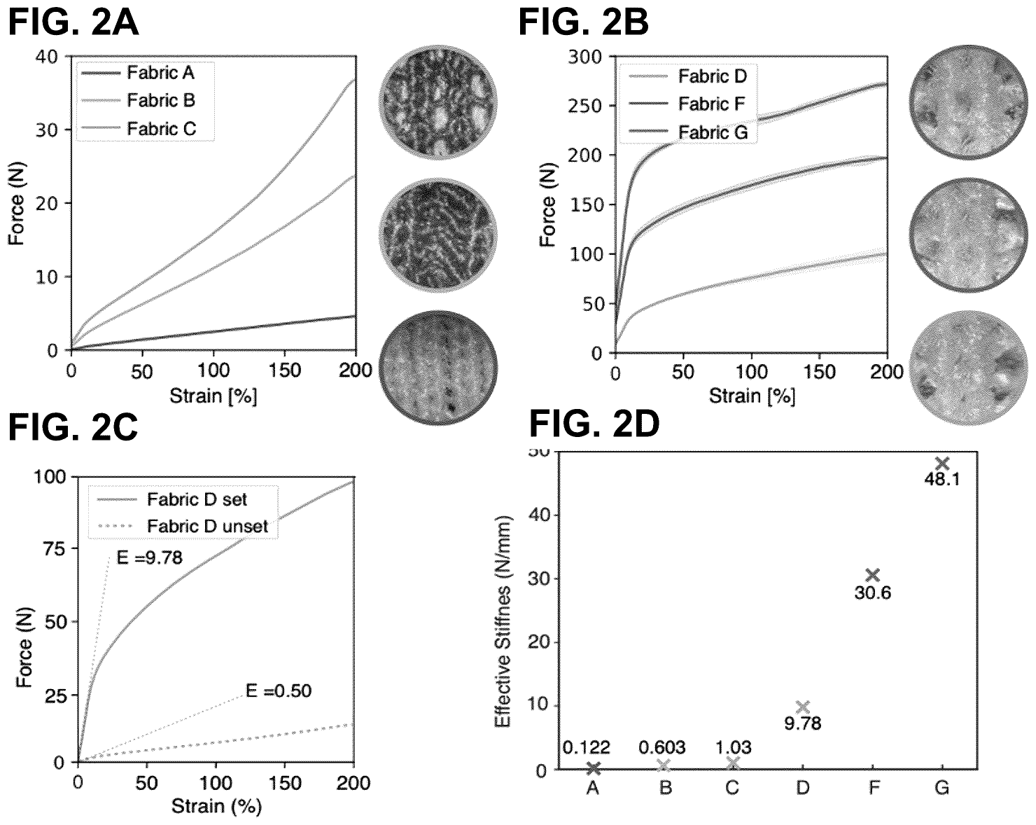

In the design provided herein, three low-stiffness zones of variable elasticity is required, which the inventors controlled solely through topology. First, the regions in contact with the inflatable areas of the actuators (in dark blue in FIG. 1A) expand and contract with pneumatic force. Second, a smaller elliptical region on the external surface (in grey in FIG. 1A) enables the entire system to flex with ease around the varying curvature of the forearm. Third, narrow transverse elastic regions 140 are situated between each actuator (in light blue in FIG. 1A), allowing the entire system to flex, twist, and adapt to each users' unique body shape. The inventors achieved this by modifying the knit topology only, using the exact same yarn for all three. The results in FIG. 2A show a microscopy image of the knit structure for the three zones (to the right of the graph) and their force-displacement curves; FIG. 2D outlines the corresponding effective stiffnesses.

By varying the stiffness using the topology only, the fabric stiffness is multiplied by a factor of 8.43. The fabrics exhibit typical hyperelastic behavior (most visible in Fabric C, in light blue in FIG. 2A).

To produce high-stiffness zones with sufficient contrast to completely direct the load transmission of the soft pneumatic actuators, the inventors tested three different amounts of heat-fusible yarn-one, two, and three strands—with the same base fabric. The results in FIG. 2B show how this manipulation leads to an increase of a factor of 4.92 in the material stiffness (effective stiffness values in FIG. 2D), and by a factor of almost 400 from the softest to the stiffest textile. As the amount of heat-fusible fiber is doubled and then tripled, more bubbles from hardened resin appear in the microscopy images, and the material behaves increasingly like a plastic. The inventors only used Fabric D in Haptiknit due to comfort concerns and because testing showed that its stiffness was sufficient for load transmission. As one can observe in FIG. 2C, the fabric transitions from the typical hyperelastic response of a textile to a plastic response, stiffening by a factor of 19.6.

### Fabrication and Characterization

A haptic sleeve prototype shown in FIG. 1B contains three integrated components: the sleeve, the actuators, and the air supply system. Each component was designed and characterized prioritizing comfort, discernability of haptic feedback, and portability.

### A Wearable Knit Device

Haptic feedback zones were distinguished from inert zones in the knit sleeve by adjusting the textile stiffness through a combination of material and stitch type variations, as well as heat treatment. Low-stiffness regions were knit using elastic yarns, while high-stiffness regions resulted from heat-fusing specific areas with thermoplastic fibers. The primary design requirement of the knit sleeve was to transfer actuator forces onto the skin for a wide range of arm sizes. It also had to accommodate the assembly and installation of pneumatic actuators and the routing of tubes. This was achieved with compartments, channels, and a multi-layer surface topology.

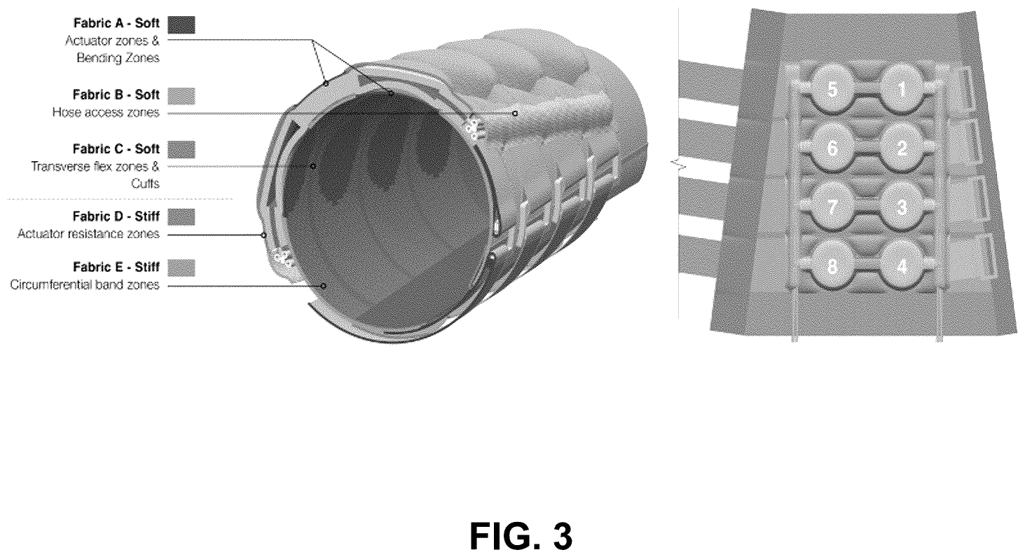

The knit panel was organized into two major layers: an inner layer (in contact with the skin) and an outer layer (within which the actuators are inserted and tubing is routed). These two layers are then composed of three individual sub-layers (six sub-layers in total), which each contain specific configurations of relatively high- and low-stiffness regions as shown in FIG. 3.

The arrangement of stiff regions was designed to maintain circumferential continuity of high-stiffness material, which concentrates the actuation forces onto the deformable areas while constraining the assembly against the body.

The Velcro straps for the sleeve are sized to accommodate the 5th percentile of women's forearm circumference (smallest fit) and the 95th percentile of men's forearm circumference (largest fit). One Velcro strap is attached to each actuator region, enabling each of the four actuator pairs to be tightened individually to maintain close skin contact in a wide variety of different arm shapes. The placement of Velcro straps also supports the stiffness continuity around the arm and are easily manipulated by the device wearer during donning and doffing.

### Soft 3D-Printed Actuator Characterization

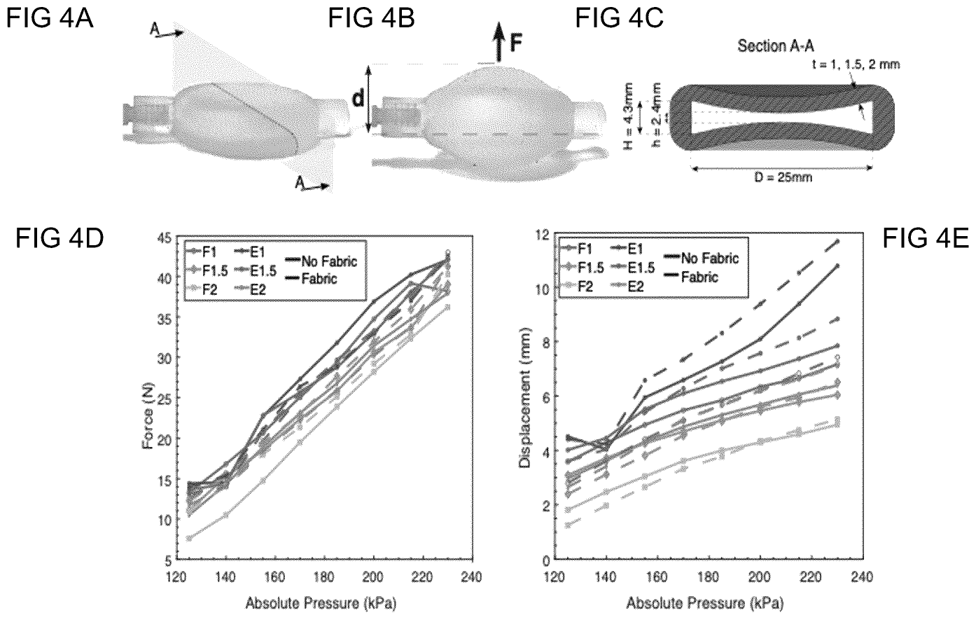

3D printing enables the fabrication of custom actuator shapes that can be seamlessly integrated into a textile. The soft actuators were manufactured using an SLA 3D printer (Formlabs Form 3). As shown in FIG. 4C, the actuators have a diameter of 25 mm and are placed on the dorsal side of the forearm in a 2×4 grid, spaced 37 mm apart center-to-center in the proximal-distal axis and 50 mm in the transverse axis. These dimensions enable one to use their social touch gesture patterns. It has been shown that a layout with this density allows for the communication of continuous motion, and the spacing is above the two-point discrimination limit reported for the lower dorsal arm.

The best material type and actuator thickness were determined through two characterization tests and under two conditions: blocked force and displacement of a single actuator, and as a standalone or between two layers of fabric (one soft, one stiff) to differentiate the actuators' performance in free space and embedded in a distributed stiffness textile. Two materials from Formlabs were tested, Elastic 50A and Flexible 80A, and three wall thicknesses: t=1.0, 1.5, and 2.0 mm (as shown in FIG. 3C)-a total of six variations. The force and displacement testing procedures are detailed in Materials and Methods. Mean results for force and displacement are shown in FIGS. 4D-E, respectively.

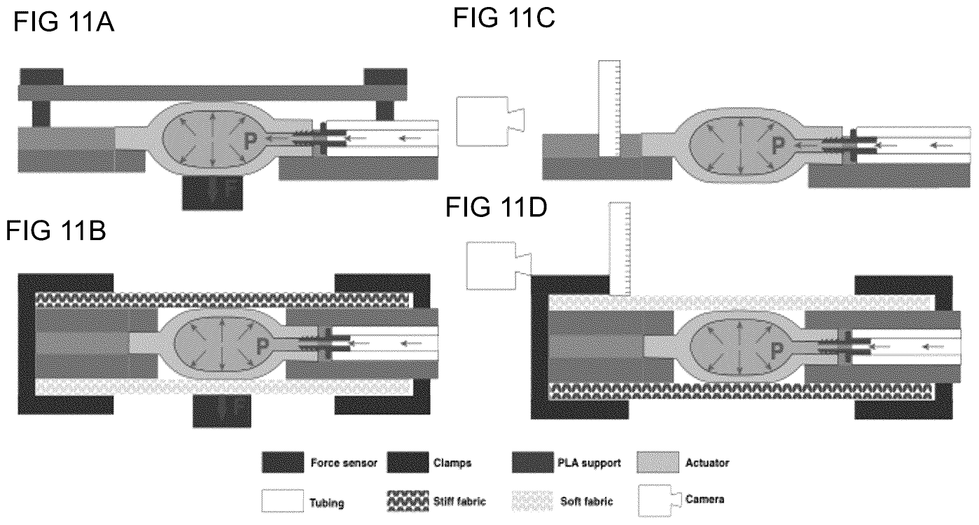

The results in FIGS. 4D-E indicate that all actuator variations achieved a minimum of 35 N force and displacements exceeding 5 mm at the maximum pressure of 230 kPa. In the cases where the force and displacement are constrained by the stiff and soft textile layers (dashed lines), the forces achieved were equal to or greater than those in the unconstrained tests. In this configuration, actuators also achieved higher displacement values. Considering the test setups shown in FIGS. 11C and 11D, this is because the stiff textile layer under the actuators completely constrains displacement in that direction (FIG. 11C), whereas in the unconstrained case the actuators can inflate in both directions (FIG. 11C).

The higher elasticity of Elastic 50A actuators increases their deformation potential. This directly affects their displacement values and increases the contact surface with the force sensor, leading to consistently higher values in both tests.

Thinner actuators achieve greater force and displacement values for a similar reason. However, Elastic 50A actuators of 1.5 mm and below had a failure rate of 25%, and 1 mm thick Flexible 80A actuators had a failure rate of 50%. Favoring system robustness and durability, the inventors thus used actuators printed with Elastic 50A and 2 mm wall thickness. They provided maximum displacements of roughly 5 mm and forces of 28 N at the standard system pressure (185 kPa). The pressure was chosen to limit force transmission at values under 30 N for comfort and safety concerns.

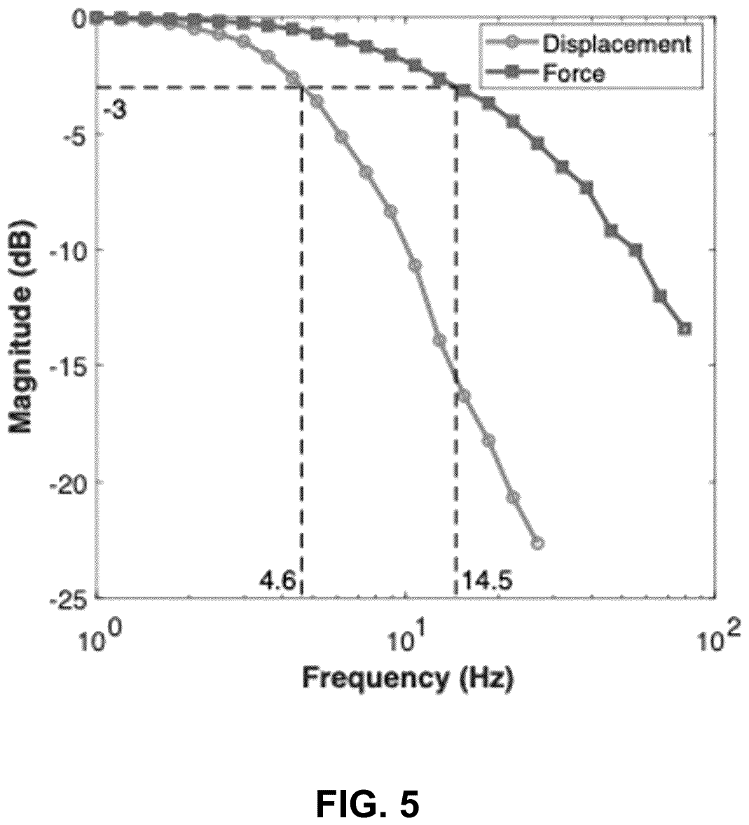

The frequency response and bandwidth of the final actuator configuration were characterized. Resulting graphs are shown in FIG. 5. The −3 dB line in FIG. 5 indicates a reduction of the signal power by 50%, i.e., bandwidth, and is reached at frequencies of 4.6 and 14.5 Hz for displacement and force, respectively. This means that forces perceived as skin indentation can be varied at frequencies higher than the human volitional movement bandwidth (˜10 Hz), which implies that the actuators can induce haptic sensations that feel natural. The indentation of the bellows into the skin of the forearm decreases at higher frequencies but remains perceptible at levels even higher than 10 Hz, because it stimulates a range of slowly adapting mechanoreceptors, namely Merkel discs and Ruffini endings.

### AirPort 1.0: A Portable Pneumatic System for Soft Robotics

Portability is crucial for the ambulatory potential of wearable devices. To make the development of untethered soft robots more accessible, FlowIO has been introduced as an open-source miniature pneumatic supply system. A customized version was used to power the Haptiknit, with modifications to address the specific needs (see details in Materials and Methods).

The final system can thus provide a bi-stable air supply, where each port can switch independently between the inflation channel supplied by the positive pressure pump, or the deflation channel connected to the vacuum pump. Thus, there are four possible states for each port: inflating, holding pressure, deflating with vacuum, and ambient pressure.

### User-Study

A three-part user-study was performed to verify the efficacy of using pneumatic actuators instead of vibration in three scenarios for both affective and discriminative touch. The study has a maximum pressure calibration step, three tests, and a post-experiment assessment. In calibration, the maximum pressure was determined based on user feedback. In the first user test, the participants experienced and rated nine stroking patterns (affective touch). In the second, they estimated the location of individual actuators (discriminative touch). In the third, they interpreted and rated six social touch gestures provided by the sleeve (affective touch). The post-experiment assessment included an open-ended discussion, during which users provided five ratings on perceived task accuracy and sleeve design. Details for the calibration and the comprehensive testing procedure are given in Materials and Methods below.

### Stroking Patterns

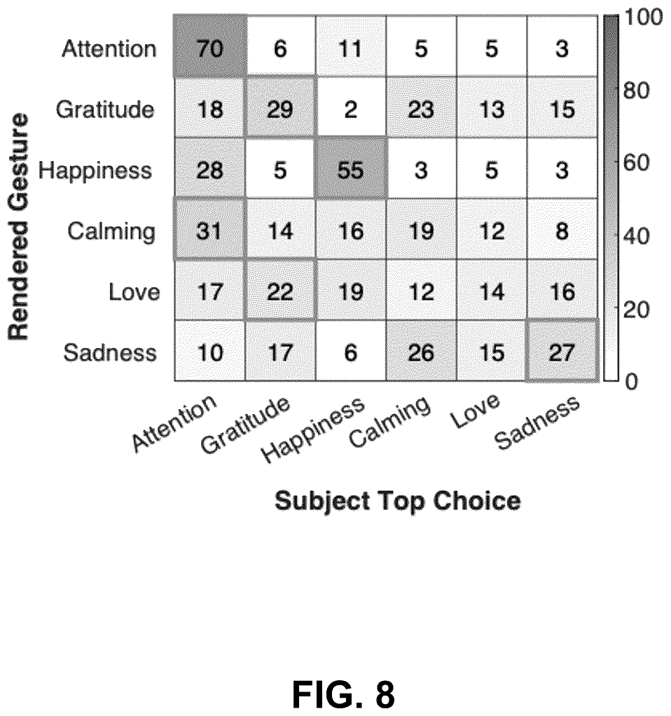

To replicate a stroking sensation, actuators 5 through 8 were inflated (as shown in FIG. 8) in sequential order, varying the duration of and delay between each actuation. Delays are the percentage of the inflation duration after which the next actuator in the stroke starts to inflate. After each of nine stroking patterns was played, participants were asked to rate their perceived continuity using an 8-point Likert scale where 0=Discrete and 7=continuous, and pleasantness using a 15-point Likert scale where −7=Very Unpleasant, 0=Neutral, and +7=Very Pleasant.

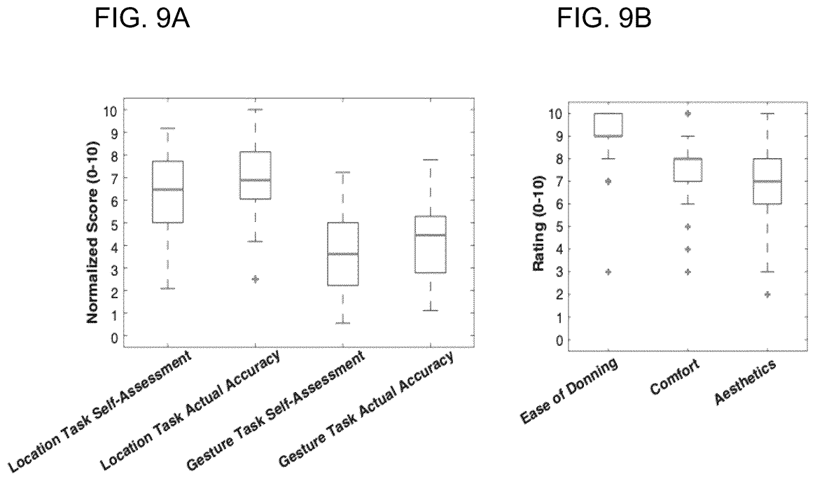

FIG. 9A shows the average continuity ratings normalized to the same 1-to-7 scale and their standard deviations sorted by duration and delay. Rated continuity decreased with inflation duration when delay was held constant and decreased with delay when the duration was held constant.

Similarly, FIG. 9B shows the average pleasantness ratings and their standard deviations organized by pulse width and delay. All ratings are greater than or equal to zero on average, implying that no stroke was perceived as unpleasant. The pattern with shortest inflation duration and largest delay was perceived most pleasant, while increasing the duration generally lowered the pleasantness. For short inflation durations of 200 ms, increasing the delay raised pleasantness; for longer inflation durations, it showed the opposite effect and decreased pleasantness.

### Actuation Localization Identification

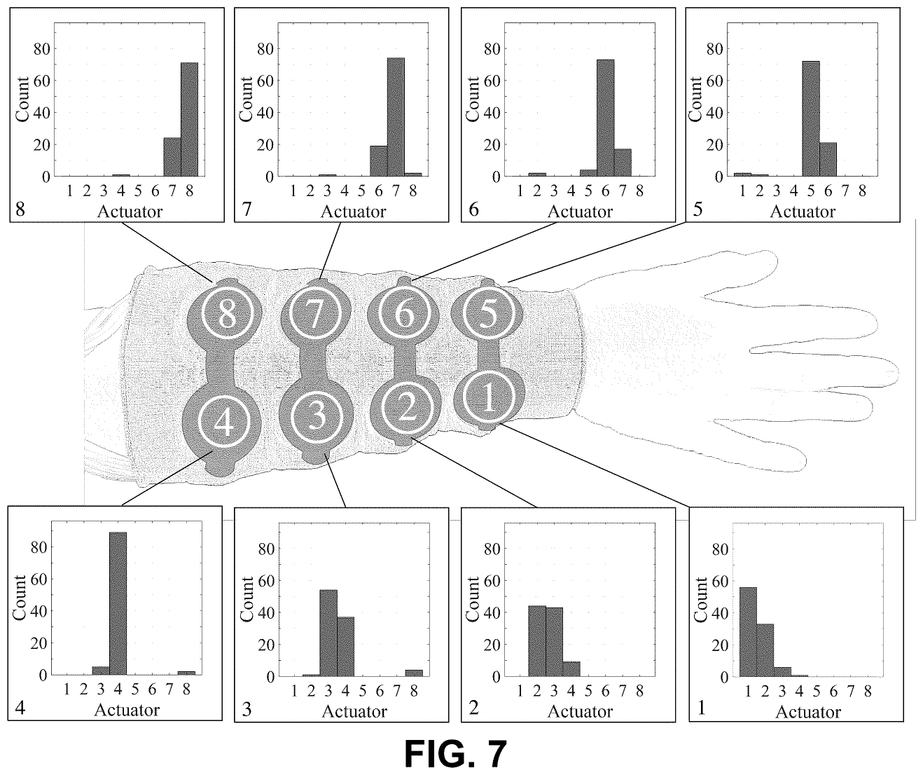

In the second part of the user test, actuator localization accuracy was evaluated to assess the feasibility of employing our concept, as opposed to vibration, for creating a tactile display. Actuators were inflated to the calibrated maximum pressure one at a time and asked the participants to guess which actuator had been inflated, using the 1-8 location numbering shown in FIGS. 3 and 7.

FIG. 7 shows the localization performance distribution by actuator. The guesses were summed across all participants and runs for when a specific actuator was inflated. The overall accuracy across the experiment was 69%, more than 5.5 times chance. In every instance, the correct actuator was consistently the top choice, and the second highest scoring actuator location was directly adjacent and in the same row. The side of the forearm, inner (#5-8) or outer (#1-4) forearm, was correctly guessed in 98% of the cases. Additionally, it was observed that the actuation stimuli on the inner side of the forearm were predicted correctly in 76% of the cases, compared to 63% on the outer side of the forearm.

### Social Touch Gestures

The third and final experiment explored the interpretation of six common social touch scenarios that were previously studied and mapped to the 2×4 actuator layout. It has been shown that these emotions can be reliably signaled through nonverbal communication.

The confusion matrix shown in FIG. 8 displays the aggregated top choices across all users and runs for each executed gesture, normalized row-wise. Whenever the percentages provided by the participant created a tie for top choice, the point for the top choice was distributed proportionally among the gestures that shared the highest attributed percentage. The total classification accuracy was 36%, 2.2 times the rate of chance. Attention and Happiness gestures were guessed correctly at more than 3 times rate of chance with the primary confusion being between the two. Gratitude and Sadness were guessed correctly at more than 1.6 times rate of chance and were also the top choice for their respective scenario. The Calming and Love gestures exhibited significant confusion, approaching chance levels. This confusion led to the selection of alternative gestures, with Attention replacing Calming and Gratitude taking the place of Love as the top choices, respectively.

The recall for a played gestured is the true positive rate, defined as the percentage of how often a gesture was correctly guessed when presented. All the gesture scored recall values 9% to 16% lower than in the confusion matrix presented in FIG. 8. A row-wise Bhattacharyya coefficient calculation between our results and theirs, serving as an indicator of the overlap between two distributions, reveals high similarities of 96%, 89%, 96%, 95%, 92% and 97% by row and gesture, respectively.

Happiness received the highest average valence rating of 6.25 and Sadness the lowest, 4.66. Happiness also had the highest average arousal rating of 7.31, over 1.5 points greater than any of the other rendered gestures. Gratitude had the highest average authenticity rating of 6.88 and Happiness had the lowest, 3.41.

### Post-Experiment Ratings

After the experiments, users were asked to self-assess their performance in the localization and gesture tasks. They indicated how many of the twenty-four single actuations they thought they localized correctly, and for how many of the eighteen played gestures they thought they made the right top choice. Participants were also asked to rate the ease of donning, comfort, and aesthetics of Haptiknit on a Likert scale from 0=very bad to 10=very good. While assessing the tasks and rating the sleeve, participants were also encouraged to comment on their choices.

Participants' self-assessment, normalized to a 10-point scale, matched their actual accuracy for both the localization task and gesture task (shown in FIG. 9A). The gesture task had lower accuracy, with a median normalized rating of 4.4 compared to 6.9 of the localization task.

In the post-experiment discussion, participants described the importance of actuation frequency when assessing which social scenario was being played. P17 said: Sadness and Gratitude I thought of as a slower movement. Attention and Happiness was a faster movement. But the nuances between those were more difficult. Love was less defined for me.” Applied force was also mentioned as a determining factor, P31: “The lighter [patterns] felt like Gratitude or Attention. The deeper and more intense [patterns] felt like Love, Calming, or Sadness.” Another factor was the location of actuation on the arm. P31: “Some of the gestures were on one side of the arm and some were on both sides. The ones that were on both sides I interpreted as more intimate or more intense.” P3 described how sleeve placement and fit determined perceived haptic feedback: “I did feel there was some space between the sleeve and skin [by the wrist]. I definitely felt less feedback on the ones near the wrist.”

The results from the Likert scale indicated median values of 9 for ease of donning, 8 for comfort, and 7 for aesthetics. Only the aesthetics rating showed mean variations of over one point in relation with participants' previous experience using human-machine interactive devices. The median aesthetic ratings varied from 6 for individuals with no experience, to 7 for those with limited or moderate experience, and further increased to 8.5 for individuals with extensive experience.

Multiple participants commented on the comfort. The participant arm position required during the experiment, with the elbow on a soft cloth on the table and the forearm held up, contributed to multiple participant comments that this position was uncomfortable.

User feedback confirmed that key design features, such as selected low stiffness regions and the closing mechanism of the sleeve, enable easy donning, comfortable wear, and pleasant aesthetics, especially among users with previous experience testing haptic devices.

### Materials and Methods

### Distributed Stiffness Fabric Characterization

Homogeneous swatches are knitted using the specifications listed in Table 1. Each refers to a specific region of the Haptiknit prototype. One can begin by obtaining optical microscopy images (Nikon Eclipse MA200) from these textile swatches prior to mechanical testing.

TABLE 1
Fabric materials and topologies. All low-stiffness materials use the same yarn but
with varying topology, and all high-stiffness materials have the same spacer construction,
but with increasing amount of heat-fusible yarn in the inner layer.

| | Fabric | Material | Topology |
|---|---|---|---|
| Low-Stiffness | A | Yeoman 540 Denier 80% Nylon, | 2 × 1 half-gauge rib |
| | B | 20% Lycra | Double knit fabric, front: 1/2 |
| | | | gauge single jersey, back: 1/4 |
| | | | gauge single jersey |
| | C | | Spacer fabric - front and back |
| | | | layers: double knit single jersey; |
| | | | inner layer only tucks between |
| | | | front and back |
| High-Stiffness | D | Low-stiffness fabric + one | Spacer fabric - front and back |
| | | strand HMS-Griltech 390-Denier | layers: double knit single jersey |
| | | Grilon K85 | of elastic yarn; inner layer of |
| | F | Low-stiffness fabric + two | heat-fusible yarn (one, two, or |
| | | strands HMS-Griltech 390- | three strands) |
| | | Denier Grilon K85 | |
| | G | Low-stiffness fabric + three | |
| | | strands HMS-Griltech 390- | |
| | | Denier Grilon K85 | |

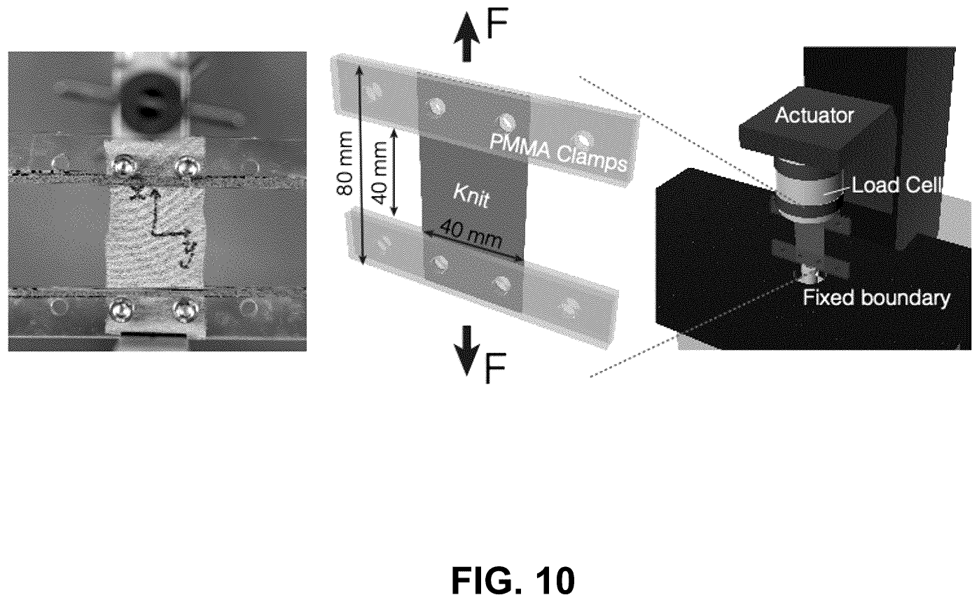

The ASTM D4694-96 Standard is adapted to characterize the tensile properties of the different fabrics. A a universal testing machine (Instron 68SC-2) was used with tensile grips to apply tension. To prepare the samples, the inventors laser cut rectangular patches of size 80×40 mm using a CO2 laser engraver (Trotec Speedy 360) from each textile swatch. Three patches are cut in each of the course direction as indicated by the orientation of the longer edge. From these, both the top and the bottom edges are clamped with PMMA clamps as shown in FIG. 10 so that the gauge area is 40×40 mm. Considering that some yarns are viscoelastic, we ensure a constant displacement rate of 1 mm/s. Maximum strain is set to 200%. We capture the deformation with a digital video camera to further understand the damage mechanisms.

The inventors chose to normalize the measured quantities by assuming the fabrics are membrane-like materials with potentially variable thicknesses across the different fabric types. Thereby the effective stiffness can be calculated from the force resultants (stress integrated over thickness or measured force divided by the width) and the measured strains, i.e.,

$${{E}_{eff} = \frac{d ( \frac{f}{w} )}{d ( \frac{Δ}{l} )} \vert}_{Δ = 0}$$

where f is the measured reaction force and A is the measured displacement. As the gauge area is w=40 mm, and l=40 mm, the equation reduces to finding the slope of the force displacement plots,

$${{E}_{eff} = \frac{df}{d Δ} \vert}_{Δ = 0} .$$

This is numerically calculated using linear regression with a fixed intercept at (0,0) to 5% strain using the following equation:

$$E = \frac{{ΣΔ}_{i} {f}_{i}}{{Δ}_{i}^{2}} .$$

The linear regression curve is shown for Fabric D before and after thermosetting in FIG. 2C.

### AirPort 1.0 Specifications

AirPort 1.0 was adapted from the open-source design known as FlowIO. First, the inventors increased the number of output valves from five to eight to control each actuator in the sleeve independently. Second, they also changed the pumps and used the Skoocom SC3802PM positive pressure pump from FlowIO's large-sized pump module and a Skoocom SC1804PM vacuum pump from the medium-sized module to obtain the pressure range needed for the soft pneumatic actuators. Third, they removed the block on the second common air channel of FlowIO's SMC S070 solenoid valves.

### Actuator Characterization Test Setup

Force was measured with a Nano 17 sensor (from ATI Industrial Automation) and displacement was measured using a stereo camera (Microntracker 3 Sx60). The inventors characterized actuators using two soft materials (Elastic 50A and Flexible 80A from Formlabs, where 50A and 80A are the shore hardness), and three bellow thicknesses (1.0 mm, 1.5 mm and 2.0 mm). The force test setups are shown in FIGS. 11A and 11B, and the displacement test setups are shown in FIGS. 11C and 11D. Each parameter combination was tested four times using new actuators each time.

The frequency response and bandwidth were measured in the unconstrained setups (no fabric) using a square-wave pneumatic input at the nominal system pressure of 185 kPa. We induced a frequency sweep starting at 1 Hz with increments of a factor of 1.2. We measured both displacement d and force response F, computing each magnitude in dB as

$$20 \cdot \frac{d}{{d}_{max}} and 20 \cdot \frac{F}{{F}_{max}}$$

respectively. They measured displacements at input frequencies up to 30 Hz, beyond which the actuator displacements were too small to be reliably tracked. Forces were measured up to a frequency of 80 Hz, approaching the physical switching delay limit of the solenoid valves installed in the pneumatic control system.

### Design and Fabrication of the Knit Sleeve

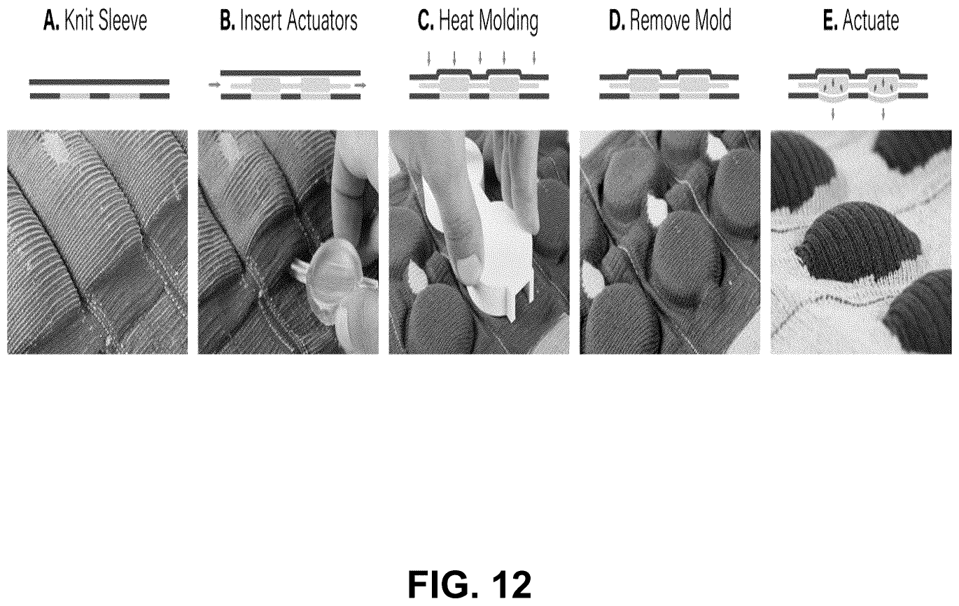

The sleeve was designed in the Create+ software interface and fabricated on a STOLL CMS 330 HP-W TT Sport industrial flatbed knitting machine. All knitting layers are fabricated simultaneously in a single seamless textile. As shown in the assembly process in FIG. 12, when heat is applied in postprocessing the layers bond and stiffen.

The sleeve assembly involves the following steps (also illustrated in order in FIG. 12):
1. Four soft actuator pairs are roughly placed inside compartments in the sleeve;
2. The whole sleeve is placed in an oven for ten minutes at 115.5° C.;
3. The actuator compartments are pressed down for 45 seconds using a die that matches the actuator dimensions and position;
4. The whole sleeve is set on a conical tube (roughly forearm shaped);
5. Once the sleeve has cooled, Velcro straps are attached at the height of the actuator compartments to ensure close skin contact and easy donning/doffing.

What is claimed is:

1. A pneumatic haptic sleeve, comprising:
(a) a knitted sleeve with a top side comprising a top stiffness area and a bottom side comprising a bottom stiffness area, wherein the top stiffness area is a high stiffness area which is different from and relative to the bottom stiffness area which is a low stiffness area; and
(b) a pneumatic actuator with a top side and a bottom side, wherein the top side ranges, while is non-actuated state, from being a concave top side to at most a flat top side, wherein the bottom side ranges, while is non-actuated state, from being a concave bottom side to at most a flat bottom side, and wherein the pneumatic actuator fits within the knitted sleeve such that the top side of the pneumatic actuator matches up with the top stiffness area, and the bottom side of the pneumatic actuator matches up with the bottom stiffness area,
wherein the pneumatic actuator, once actuated, the top stiffness area limits or prevents bulging resulting from the actuated pneumatic actuator at the top stiffness area such that the top side, while in this actuated state, ranges from between the concave top side to at most the flat top side, and
wherein the pneumatic actuator, once actuated, the bottom stiffness area allows bulging resulting from the actuated pneumatic actuator at the bottom stiffness area, such that the bottom side, while in this actuated state, ranges from between the concave bottom side to a convex bottom side.

2. The pneumatic haptic sleeve as set forth in claim 1, wherein the high stiffness area comprises heat-fusible fibers or heat-fusible thermoplastics.

3. The pneumatic haptic sleeve as set forth in claim 1, wherein the high stiffness area is an area with a varying topology.

4. The pneumatic haptic sleeve as set forth in claim 1, wherein the high stiffness area has a stiffness range from 9.78 N/mm to 48.1 N/mm.

5. The pneumatic haptic sleeve as set forth in claim 1, wherein the lows stiffness area is a knitted area of elastic yarn.

6. The pneumatic haptic sleeve as set forth in claim 1, wherein the lows stiffness area is a knitted area with a varying topology.

7. The pneumatic haptic sleeve as set forth in claim 1, wherein the low stiffness area has a stiffness range from 0.122 N/mm to 1.03 N/mm.
